(19) United States
(12) Patent Application Publication
(10) Pub. No.: US 2015/0252187 A1
(43) Pub. Date: Sep. 10, 2015

(54) MULTIFUNCTIONAL ENVIRONMENTALLY PROTECTIVE POLYURETHANE COMPOSITE MATERIAL AND METHOD OF MAKING THE SAME

(71) Applicant: SUNKO INK CO., LTD., Taichung (TW)

(72) Inventors: Chia-Pang Liu, Taichung (TW); Chien-Chia Chu, Taichung (TW); Chien-Yuan Chiu, Taichung (TW); Ming-Yu Chen, Taichung (TW); Ting-Kai Huang, Taichung (TW); Yi-Jung HUANG, Taichung (TW)

(73) Assignee: SUNKO INK CO., LTD., Taichung (TW)

(21) Appl. No.: 14/200,410

(22) Filed: Mar. 7, 2014

(51) Int. Cl. C08L 75/04

(52) U.S. Cl. CPC C08L 75/04

(57) ABSTRACT

A multifunctional environmentally protective polyurethane composite material comprises a thermoplastic polyurethane; an environmentally protective additive including recycled polymer, plant fiber, mineral, or metal powder; and a thickening dispersant including natural rubber or synthetic rubber. By the thickening dispersant, the environmentally protective additive is uniformly added into the thermoplastic polyurethane to form the multifunctional environmentally protective polyurethane composite material. The environmentally protective additive can reduce the existing amount of waste or suppress increase of waste. With the use of the thickening dispersant and the environmentally protective additive, the multifunctional environmentally protective polyurethane composite material has advantages of light weight, good flowability, slip resistance, abrasion resistance, formability and low cost.

### BACKGROUND OF THE INVENTION

1. Field of the Invention

The present invention relates to a polyurethane polymeric material and a method of making the same, and particularly to a multifunctional environmentally protective polyurethane composite material and a method of making the same.

2. Description of the Prior Art(s)

Recently, due to public awareness about ecological and environmental issues, the use of environmentally friendly materials that are recyclable, light-weighted, and easily processed is an inevitable trend. Polymer composites can produce synergistic effects, and also may retain the respective properties of each component.

Thermoplastic polyurethane (TPU) has the advantages of conventional engineering plastics, and also has excellent properties, such as high impact resistance, high flexing resistance, high elongation, high tear-resistance strength, high weather resistance and so on. In addition, owing to the non-toxic nature of thermoplastic polyurethane, thermoplastic polyurethane has been widely used as an environmentally friendly material and therefore has wide application. For example, thermoplastic polyurethane can be applied to elastic fibers, artificial leather resins, adhesives, pipes, and other protective materials. Furthermore, in order to improve the properties of thermoplastic polyurethane and the economic benefits, additives of thermoplastic polyurethane are currently used in the industry. Additives can not only reduce the amount of thermoplastic polyurethane and production costs, but also increase the physical and chemical properties of thermoplastic polyurethane.

Conventional additives of thermoplastic polyurethane include: the inorganic material used to increase the strength of thermoplastic polyurethane; the antioxidants, stabilizers, and flame resistant agents used to improve the stability and fire resistance of thermoplastic polyurethane; the organic antistatic agents used to enhance the antistatic effect of thermoplastic polyurethane; the ultraviolet protective agents used to increase the ultraviolet resistance of thermoplastic polyurethane; and the lubricants used to improve the processability and flowability of thermoplastic polyurethane.

The conventional additives mentioned above may enhance the chemical and physical properties of thermoplastic polyurethane, such as the strength, the stability, the fire resistance, the antistatic effect, the ultraviolet resistance and the processing flowability, but the type and origin of the conventional additives are not entirely beneficial to the environment, some of which may even cause additional burdens or harm to the environment.

To overcome the shortcomings, the present invention provides a multifunctional, environmentally protective polyurethane composite material and a method of making the same to mitigate or obviate the aforementioned problems.

### SUMMARY OF THE INVENTION

The main objective of the present invention is to add an environmentally protective additive into thermoplastic polyurethane, so as to achieve the purpose of increasing the physical and chemical properties of the thermoplastic polyurethane as well as environmental protection.

To achieve the aforementioned objective, the present invention provides a multifunctional environmentally protective polyurethane composite material comprising a thermoplastic polyurethane; an environmentally protective additive including a substance selected from the group consisting of: recycled polymer, plant fiber, mineral and metal powder; and a thickening dispersant including a substance selected from the group consisting of: natural rubber and synthetic rubber.

In accordance with the present invention, the environmentally protective additive is not limited to recycled materials, but further comprises an environmentally friendly additive. The environmentally protective additive would not produce additional waste or can even suppress increase of waste.

In accordance with the present invention, the recycled polymer is selected from the group consisting of: polyethylene (PE), polyvinyl chloride (PVC), polypropylene (PP), polystyrene (PS), polyethylene terephthalate (PET), nylon, fluoride plastic, polyimide (PI), polycarbonate (PC), acrylonitrile butadiene styrene (ABS) and tire. As a result that the origin of the recycled polymer is a waste material, using the recycled polymer as the environmentally protective additive will reduce the existing amount of waste and further suppress the increase of waste.

In accordance with the present invention, the plant fiber is derived from the group consisting of: cork, bamboo charcoal, wood powder, grain shells, bagasse, coffee grounds, tea leaves, waste paper and mixtures thereof. As the plant fiber is originated from the nature and can be biologically decomposed, using the plant fiber as the environmentally protective additive will not produce additional waste but further suppress the increase of waste.

In accordance with the present invention, the mineral is selected from the group consisting of: zeolite, clay, diatomaceous earth, graphite and limestone. As the mineral is originated from the nature, using the mineral as the environmentally protective additive will not produce additional waste but further suppress the increase of waste.

Preferably, the hardness of the thermoplastic polyurethane is between 6 D and 80 D, wherein the hardness between 6 D and 80 D can be converted into between 20 A and 100 A.

Preferably, the melt index of the thermoplastic polyurethane is between 1 gram per 10 minutes and 50 grams per 10 minutes.

Preferably, the synthetic rubber of the thickening dispersant is selected from the group consisting of: polyisoprene rubber (IR), polybutadiene rubber (BR), acrylonitrile butadiene rubber (NBR), styrene-butadiene-styrene block copolymer (SBS), styrene-butadiene rubber (SBR), styrene-ethylene-butylene-styrene block copolymer (SEBS), styrene-isoprene-styrene block copolymer (SIS) and a chemically modified product thereof.

In accordance with the present invention, the chemically modified product of rubber is designated to a product produced by connecting a rubber and a polymer via a chemical method. For example, the chemically modified product of rubber is, but not limited to, maleic anhydride (MA) grafted styrene-ethylene-butylene-styrene block copolymer.

In accordance with the present invention, the thermoplastic polyurethane is made from a polyol, a diisocyanate and a chain extender.

Preferably, the polyol is selected from the group consisting of: polyester, polyether and polycaprolactone.

Preferably, the average molecular weight (Mw) of the polyol is between 500 and 5000.

Preferably, the diisocyanate is selected from the group consisting of: toluene-2,4-diisocyanate, toluene-2,6-diisocyanate, 4,4′-diphenylmethane diisocyanate, 2,4′-diphenylmethane diisocyanate, polymeric diphenylmethane diisocyanate and hexamethylene diisocyanate.

Preferably, the chain extender is selected from the group consisting of: ethylene glycol, 1,4-butanediol and 1,6-hexanediol.

In accordance with the present invention, the concentration of the thickening dispersant is 0.1 to 80 weight percent (wt %) based on the weight of the multifunctional environmentally protective polyurethane composite material.

In accordance with the present invention, the concentration of the environmentally protective additive is 0.1 to 80 weight percent (wt %) based on the weight of the multifunctional environmentally protective polyurethane composite material.

In addition, the present invention provides a method for making the multifunctional environmentally protective polyurethane composite material comprising the steps of blending the thermoplastic polyurethane, the environmentally protective additive and the thickening dispersant to obtain a mixture; and molding the mixture to obtain the multifunctional environmentally protective polyurethane composite material.

Preferably, in the step of blending the thermoplastic polyurethane, the environmentally protective additive and the thickening dispersant to obtain a mixture, the environmentally protective additive and the thickening dispersant are blended under an operation temperature ranging from 25° C. to 70° C., a screw speed ranging from 50 revolutions per minute to 200 revolutions per minute and a blending time ranging from 0.5 hour to 1 hour to obtain an intermediate. Then the intermediate is blended with the thermoplastic polyurethane under an operation temperature ranging from 50° C. to 60° C., a screw speed ranging from 50 revolutions per minute to 200 revolutions per minute and a blending time ranging from 0.5 hour to 1 hour to obtain the mixture.

Preferably, in the step of molding the mixture to obtain the multifunctional environmentally protective polyurethane composite material, the mixture is melted and extruded under a melting temperature ranging from 130° C. to 220° C. and a screw speed ranging from 50 revolutions per minute to 120 revolutions per minute to obtain the multifunctional environmentally protective polyurethane composite material.

Based on the present invention, by the thickening dispersant, the environmentally protective additive is uniformly added into the thermoplastic polyurethane to form the multifunctional environmentally protective polyurethane composite material. The environmentally protective additive can reduce the existing amount of waste or further suppress increase of waste. In addition, the multifunctional environmentally protective polyurethane composite material is light-weighted, slip-resistant, abrasion-resistant, highly processable and low-cost with the use of the thickening dispersant and the environmentally protective additive.

Other objectives, advantages and novel features of the invention will become more apparent from the following detailed description when taken in conjunction with the accompanying drawings.

### BRIEF DESCRIPTION OF THE DRAWINGS

FIG. 1 is a flow diagram of a method of making the multifunctional environmentally protective polyurethane composite material in accordance with the present invention.

### DETAILED DESCRIPTION OF THE PREFERRED EMBODIMENTS

For a better understanding about the technical features of the present invention and its effect, and for implements in accordance with the disclosures of the specification, embodiments, details and figures are further shown as follows.

In each embodiment in accordance with the present invention, properties of the multifunctional environmentally protective polyurethane composite material of each embodiment are evaluated based on thermoplastic polyurethane of each embodiment.

In accordance with the present invention, the analysis method of material properties is as follows.

Light weight was represented by specific gravity. A material with lower specific gravity had a lighter weight.

Flowability was represented by melt index. A material with larger melt index had a better flowability.

Slip resistance was represented by coefficient of friction (COF) measured by ASTM F2913-11. A material with larger COF had a better slip resistance.

Formability was represented by manufacturing cycle time. A material with shorter manufacturing cycle time had a better formability.

Abrasion resistance was represented by volume loss measured by DIN-53516. A material with less volume loss had a better abrasion resistance.

### Embodiment 1

In the present embodiment, a multifunctional environmentally protective polyurethane composite material in accordance with the present invention comprises a thermoplastic polyurethane, an environmentally protective additive and a thickening dispersant.

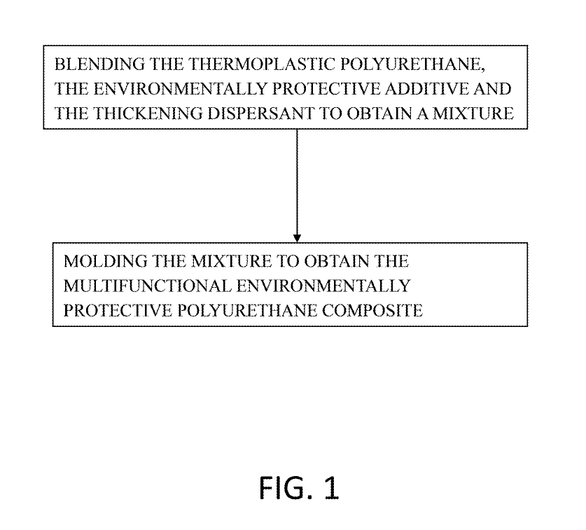

With reference to FIG. 1, a method of making the multifunctional environmentally protective polyurethane composite material of the present embodiment comprises steps as follows.

The environmentally protective additive and the thickening dispersant were blended by an agitator-type blender under an operation temperature of 25° C., a screw speed of 150 revolutions per minute (r.p.m.), and a blending time of 1 hour; an intermediate was obtained.

The intermediate was blended with the thermoplastic polyurethane by the agitator-type blender under an operation temperature of 60° C., a screw speed of 150 r.p.m. and a blending time of 1 hour; a mixture was obtained.

The mixture was melted and extruded by an extrusion moulding machine under a melting temperature of 180° C. and a screw speed of 70 r.p.m.; the multifunctional environmentally protective polyurethane composite material was obtained.

In the present embodiment, the thermoplastic polyurethane was TPU-785 manufactured by Sunko Ink. Co., Ltd. The hardness and the melt index of the thermoplastic polyurethane were 85 A and 14.318 grams per 10 minutes (g/10 mins), respectively. The environmentally protective additive was cork. The thickening dispersant was polybutadiene rubber manufactured by TSRC Corp. The product ID of the polybutadiene rubber was TAIPOL BR0150L. The weight ratio between the thermoplastic polyurethane, the environmentally protective additive and the thickening dispersant was 40:30:30.

With reference to Table 1, in the present embodiment, the specific gravity of the multifunctional environmentally protective polyurethane composite material and the specific gravity of the thermoplastic polyurethane was respectively 1.803 and 1.196. Accordingly, by the use of cork, the multifunctional environmentally protective polyurethane composite material of the present embodiment had a lower specific gravity than the thermoplastic polyurethane. That is, the multifunctional environmentally protective polyurethane composite material of the present embodiment was light-weighted.

TABLE 1
Analysis result of material property of Embodiment 1

| | Specific gravity |
|---|---|
| Multifunctional environmentally protective | 1.083 |
| polyurethane composite material | |
| Thermoplastic polyurethane | 1.196 |

### Embodiment 2

The present embodiment was similar to Embodiment 1. The difference between the present embodiment and Embodiment 1 was that the mixture was melted and extruded by the extrusion moulding machine under a melting temperature of 200° C. and a screw speed of 90 r.p.m. to obtain the multifunctional environmentally protective polyurethane composite material.

In addition, in the present embodiment, the thermoplastic polyurethane was TPU-195 manufactured by Sunko Ink. Co., Ltd. The hardness and the melt index of the thermoplastic polyurethane were 95 A and 7.164 g/10 mins, respectively. The environmentally protective additive was recycled tire powder. The thickening dispersant was polybutadiene rubber manufactured by TSRC Corp. The product ID of the polybutadiene rubber was TAIPOL BR0150H. The weight ratio between the thermoplastic polyurethane, the environmentally protective additive and the thickening dispersant was 60:20:20.

With reference to Table 2, in the present embodiment, the melt index of the multifunctional environmentally protective polyurethane composite material and the melt index of the thermoplastic polyurethane were respectively 8.753 g/10 mins and 7.164 g/10 mins. Accordingly, by use of recycled tire powder, the multifunctional environmentally protective polyurethane composite material of the present embodiment had a higher melt index than the thermoplastic polyurethane. That is, the multifunctional environmentally protective polyurethane composite material of the present embodiment had a better flowability and was easily processed.

TABLE 2
Analysis result of material properties of Embodiment 2

| | Melt index |
|---|---|
| Multifunctional environmentally protective | 8.753 g/10 min |
| polyurethane composite material | |
| Thermoplastic polyurethane | 7.164 g/10 min |

### Embodiment 3

The present embodiment was similar to Embodiment 1. The difference between the present embodiment and Embodiment 1 was that the mixture was melted and extruded by the extrusion moulding machine under a melting temperature of 200° C. and a screw speed of 90 r.p.m. to obtain the multifunctional environmentally protective polyurethane composite material.

In addition, in the present embodiment, the thermoplastic polyurethane was TPU-975 manufactured by Sunko Ink. Co., Ltd. The hardness of the thermoplastic polyurethane was 75 A. The thickening dispersant was acrylonitrile butadiene rubber manufactured by TSRC Corp. The product ID of the acrylonitrile butadiene rubber was TAIPOL NBR8052. The weight ratio between the thermoplastic polyurethane and the thickening dispersant was 50:50.

With reference to Table 3, in the present embodiment, the COF of the multifunctional environmentally protective polyurethane composite material was larger than that of the thermoplastic polyurethane. Also, the manufacturing cycle time of the multifunctional environmentally protective polyurethane composite material was shorter than that of the thermoplastic polyurethane. Accordingly, by use of the thickening dispersant, the multifunctional environmentally protective polyurethane composite material of the present embodiment had a better slip resistance and a better formability than the thermoplastic polyurethane.

TABLE 3
Analysis result of material properties of Embodiment 3

| | | manufacturing |
|---|---|---|
| | COF | cycle time |
| Multifunctional environmentally | 0.43 | 22 seconds |
| protective polyurethane | | |
| composite material | | |
| Thermoplastic polyurethane | 0.32 | 36 seconds |

### Embodiment 4

The present embodiment was similar to Embodiment 1. The difference between the present embodiment and Embodiment 1 was that the mixture was melted and extruded by the extrusion moulding machine under a melting temperature of 215° C. and a screw speed of 90 r.p.m. to obtain the multifunctional environmentally protective polyurethane composite material.

In addition, in the present embodiment, the thermoplastic polyurethane was TPU-764 manufactured by Sunko Ink. Co., Ltd. The hardness and the melt index of the thermoplastic polyurethane were 64 D and 5.482 g/10 mins, respectively. The environmentally protective additive was graphite powder. The thickening dispersant was polybutadiene rubber manufactured by TSRC Corp. The product ID of the polybutadiene rubber was TAIPOL BR015H. The weight ratio between the thermoplastic polyurethane, the environmentally protective additive and the thickening dispersant was 90:5:5.

With reference to Table 4, in the present embodiment, the volume loss of the multifunctional environmentally protective polyurethane composite material was less than that of the thermoplastic polyurethane. Accordingly, by the use of the graphite powder, the multifunctional environmentally protective polyurethane composite material of the present embodiment had a better abrasion resistance than the thermoplastic polyurethane.

TABLE 4
Analysis result of material properties of Embodiment 4

| | Volume loss |
|---|---|
| Multifunctional environmentally | 51.96 meter cube (mm³) |
| protective polyurethane | |
| composite material | |
| Thermoplastic polyurethane | 63.31 meter cube(mm³) |

### Embodiment 5

The present embodiment was similar to Embodiment 1. The difference between the present embodiment and Embodiment 1 was that the mixture was melted and extruded by the extrusion moulding machine under a melting temperature of 180° C. and a screw speed of 60 r.p.m. to obtain the multifunctional environmentally protective polyurethane composite material.

In addition, in the present embodiment, the environmentally protective additive was cork and recycled tire powder. The thickening dispersant was acrylonitrile butadiene rubber manufactured by TSRC Corp. The product ID of the acrylonitrile butadiene rubber was TAIPOL NBR8052. The weight ratio between the thermoplastic polyurethane, the environmentally protective additive and the thickening dispersant was 66:17:17. The weight ratio between the cork and the recycled tire powder was 5:5.

With reference to Table 5, in the present embodiment, the specific gravity of the multifunctional environmentally protective polyurethane composite material was smaller than that of the thermoplastic polyurethane. The melt index and the COF of the multifunctional environmentally protective polyurethane composite material were both larger than those of the thermoplastic polyurethane. The manufacturing cycle time of the multifunctional environmentally protective polyurethane composite material was shorter than that of the thermoplastic polyurethane. Accordingly, by the use of the cork and the recycled tire powder, the multifunctional environmentally protective polyurethane composite material of the present embodiment had a lighter weight, a better flowability, a better abrasion resistance and a better formability than the thermoplastic polyurethane.

TABLE 5
Analysis result of material properties of Embodiment 5

| | Specific | Melt | | Manufacturing |
|---|---|---|---|---|
| | gravity | index | COF | cycle time |
| Multifunctional | 1.152 | 16.294 g/10 mins | 0.48 | 22 seconds |
| environmentally | | | | |
| protective | | | | |
| polyurethane | | | | |
| composite | | | | |
| material | | | | |
| Thermoplastic | 1.196 | 14.138 g/10 mins | 0.25 | 28 seconds |
| polyurethane | | | | |

### Embodiment 6

The present embodiment was similar to Embodiment 1. The difference between the present embodiment and Embodiment 1 was that the mixture was melted and extruded by the extrusion moulding machine under a melting temperature of 215° C. and a screw speed of 90 r.p.m. to obtain the multifunctional environmentally protective polyurethane composite material.

In addition, in the present embodiment, the thermoplastic polyurethane was TPU-764 manufactured by Sunko Ink. Co., Ltd. The hardness and the melt index of the thermoplastic polyurethane were respectively 64 D and 5.482 grams per 10 minutes (g/10 mins). The environmentally protective additive was cork, recycled tire powder and graphite powder. The weight ratio between the thermoplastic polyurethane, the environmentally protective additive and the thickening dispersant was 68:28:4. The weight ratio between the cork, the recycled tire powder and the graphite powder was 20:10:5.

With reference to Table 6, in the present embodiment, the specific gravity of the multifunctional environmentally protective polyurethane composite material was smaller than that of the thermoplastic polyurethane. The melt index of the multifunctional environmentally protective polyurethane composite material was larger than that of the thermoplastic polyurethane. The volume loss of the multifunctional environmentally protective polyurethane composite material was less than that of the thermoplastic polyurethane. Accordingly, by the use of the cork, the recycled tire powder and the graphite powder, the multifunctional environmentally protective polyurethane composite material of the present embodiment had a lighter weight, a better flowability and a better abrasion resistance than the thermoplastic polyurethane.

TABLE 6
Analysis result of material properties of Embodiment 6

| | Specific | Melt | Volume |
|---|---|---|---|
| | gravity | index | loss |
| Multifunctional | 1.163 | 6.328 g/10 mins | 58.73 mm³ |
| environmentally | | | |
| protective | | | |
| polyurethane | | | |
| composite | | | |
| material | | | |
| Thermoplastic | 1.214 | 5.482 g/10 mins | 62.31 mm³ |
| polyurethane | | | |

### Embodiment 7

The present embodiment was similar to Embodiment 1. The difference between the present embodiment and Embodiment 1 was that the mixture was melted and extruded by the extrusion moulding machine under a melting temperature of 200° C. and a screw speed of 90 r.p.m. to obtain the multifunctional environmentally protective polyurethane composite material.

In addition, in the present embodiment, the thermoplastic polyurethane was TPU-195 manufactured by Sunko Ink. Co., Ltd. The hardness and the melt index of the thermoplastic polyurethane were respectively 95 A and 7.164 grams per 10 minutes (g/10 mins). The environmentally protective additive was cork and recycled tire powder. The thickening dispersant was polybutadiene rubber manufactured by TSRC Corp. The product ID of the polybutadiene rubber was TAIPOL BR0150H. The weight ratio between the thermoplastic polyurethane, the environmentally protective additive and the thickening dispersant was 40:20:40. The weight ratio between the cork and the recycled tire powder was 20:10.

With reference to Table 7, in the present embodiment, the specific gravity of the multifunctional environmentally protective polyurethane composite material was smaller than that of the thermoplastic polyurethane. The melt index and the COF of the multifunctional environmentally protective polyurethane composite material were both larger than those of the thermoplastic polyurethane. The manufacturing cycle time of the multifunctional environmentally protective polyurethane composite material was shorter than that of the thermoplastic polyurethane. Accordingly, by the use of the cork and the recycled tire powder, the multifunctional environmentally protective polyurethane composite material of the present embodiment had a lighter weight, a better flowability, a better abrasion resistance and a better formability than the thermoplastic polyurethane.

TABLE 7
Analysis result of material properties of Embodiment 7

| | Specific | Melt | | Manufacturing |
|---|---|---|---|---|
| | gravity | index | COF | cycle time |
| Multifunctional | 1.088 | 8.577 g/10 mins | 0.56 | 15 seconds |
| environmentally | | | | |
| protective | | | | |
| polyurethane | | | | |
| composite | | | | |
| material | | | | |
| Thermoplastic | 1.198 | 7.164 g/10 mins | 0.48 | 18 seconds |
| polyurethane | | | | |

### Embodiment 8

The present embodiment was similar to Embodiment 1. The difference between the present embodiment and Embodiment 1 was that the mixture was melted and extruded by the extrusion moulding machine under a melting temperature of 170° C. and a screw speed of 90 r.p.m. to obtain the multifunctional environmentally protective polyurethane composite material.

In addition, in the present embodiment, the environmentally protective additive was cork, recycled tire powder, recycled polyethylene and diatomaceous. The weight ratio between the thermoplastic polyurethane, the environmentally protective additive and the thickening dispersant was 55:36:9. The weight ratio between the cork, the recycled tire powder, the recycled polyethylene and the diatomaceous was 30:15:10:5.

With reference to Table 8, in the present embodiment, the specific gravity of the multifunctional environmentally protective polyurethane composite material was smaller than that of the thermoplastic polyurethane. The melt index of the multifunctional environmentally protective polyurethane composite material was larger than that of the thermoplastic polyurethane. The volume loss of the multifunctional environmentally protective polyurethane composite material was less than that of the thermoplastic polyurethane. Accordingly, by the use of the cork, the recycled tire powder, the recycled polyethylene and the diatomaceous, the multifunctional environmentally protective polyurethane composite material of the present embodiment had a lighter weight, a better flowability and a better abrasion resistance than the thermoplastic polyurethane.

TABLE 8
Analysis result of material properties of Embodiment 8

| | Specific | Melt | Volume |
|---|---|---|---|
| | gravity | index | loss |
| Multifunctional | 1.182 | 16.815 g/10 mins | 92.63 mm³ |
| environmentally | | | |
| protective | | | |
| polyurethane | | | |
| composite | | | |
| material | | | |
| Thermoplastic | 1.196 | 14.318 g/10 mins | 108.42 mm³ |
| polyurethane | | | |

### Embodiment 9

The present embodiment was similar to Embodiment 1. The difference between the present embodiment and Embodiment 1 was that the mixture was melted and extruded by the extrusion moulding machine under a melting temperature of 190° C. and a screw speed of 90 r.p.m. to obtain the multifunctional environmentally protective polyurethane composite material.

In addition, in the present embodiment, the thermoplastic polyurethane was TPU-970 manufactured by Sunko Ink. Co., Ltd. The hardness and the melt index of the thermoplastic polyurethane were respectively 70 A and 5.024 grams per 10 minutes (g/10 mins). The environmentally protective additive was cork, recycled tire powder and recycled polyethylene terephthalate. The thickening dispersant was polybutadiene rubber manufactured by TSRC Corp. The product ID of the polybutadiene rubber was TAIPOL BR0150L. The weight ratio between the thermoplastic polyurethane, the environmentally protective additive and the thickening dispersant was 50:35:15. The weight ratio between the cork, the recycled tire powder and the recycled polyethylene terephthalate was 20:20:30.

TABLE 9
Analysis result of material properties of Embodiment 9

| | Specific | Melt | | Manufacturing |
|---|---|---|---|---|
| | gravity | index | COF | cycle time |
| Multifunctional | 1.18 | 8.982 g/10 mins | 0.38 | 30 seconds |
| environmentally | | | | |
| protective | | | | |
| poryurethane | | | | |
| composite | | | | |
| material | | | | |
| Thermoplastic | 1.24 | 5.024 g/10 mins | 0.31 | 38 seconds |
| poryurethane | | | | |

With reference to Table 9, in the present embodiment, the specific gravity of the multifunctional environmentally protective polyurethane composite material was smaller than that of the thermoplastic polyurethane. The melt index and the COF of the multifunctional environmentally protective polyurethane composite material were larger than those of the thermoplastic polyurethane. The manufacturing cycle time of the multifunctional environmentally protective polyurethane composite material was shorter than that of the thermoplastic polyurethane. Accordingly, by the use of the cork, the recycled tire powder and the recycled polyethylene terephthalate, the multifunctional environmentally protective polyurethane composite material of the present embodiment had a lighter weight, a better flowability, a better abrasion resistance and a better formability than the thermoplastic polyurethane.

### Embodiment 10

The present embodiment was similar to Embodiment 1. The difference between the present embodiment and Embodiment 1 was that the mixture was melted and extruded by the extrusion moulding machine under a melting temperature of 190° C. and a screw speed of 90 r.p.m. to obtain the multifunctional environmentally protective polyurethane composite material.

In addition, in the present embodiment, the thermoplastic polyurethane was TPU-970 manufactured by Sunko Ink. Co., Ltd. The hardness and the melt index of the thermoplastic polyurethane were respectively 70 A and 5.024 g/10 mins. The environmentally protective additive was recycled tire powder, wood powder and clay. The thickening dispersant was polybutadiene rubber manufactured by TSRC Corp. The product ID of the polybutadiene rubber was TAIPOL BR0150H. The weight ratio between the thermoplastic polyurethane, the environmentally protective additive and the thickening dispersant was 67:30:3. The weight ratio between the recycled tire powder, the wood powder and the clay was 30:10:5.

With reference to Table 10, in the present embodiment, the specific gravity of the multifunctional environmentally protective polyurethane composite material was smaller than that of the thermoplastic polyurethane. The melt index of the multifunctional environmentally protective polyurethane composite material was larger than that of the thermoplastic polyurethane. The volume loss of the multifunctional environmentally protective polyurethane composite material was less than that of the thermoplastic polyurethane. Accordingly, by the use of the cork, the recycled tire powder and the graphite powder, the multifunctional environmentally protective polyurethane composite material of the present embodiment had a lighter weight, a better flowability and a better abrasion resistance than the thermoplastic polyurethane.

TABLE 10
Analysis result of material properties of Embodiment 10

| | Specific | Melt | Volume |
|---|---|---|---|
| | gravity | index | loss |
| Multifunctional | 1.15 | 6.38 g/10 mins | 102.43 mm³ |
| environmentally | | | |
| protective | | | |
| polyurethane | | | |
| composite | | | |
| material | | | |
| Thermoplastic | 1.24 | 5.024 g/10 mins | 110.88 mm³ |
| polyurethane | | | |

Comparison 1

In the present comparison, a thermoplastic polyurethane was blended with cork by an agitator-type blender under an operation temperature of 25° C., a screw speed of 150 revolutions per minute (r.p.m.) and a blending time of 1 hour; then a mixture was obtained. The thermoplastic polyurethane was TPU-785 manufactured by Sunko Ink. Co., Ltd. The hardness and the melt index of the thermoplastic polyurethane were 85 A and 14.318 g/10 mins, respectively. The weight ratio between the thermoplastic polyurethane and the cork was 70:30.

The mixture was melted and extruded by an extrusion moulding machine under a melting temperature of 180° C. and a screw speed of 70 r.p.m. to obtain an environmentally protective polyurethane composite material. However, after extrusion moulding, the mixture was broken immediately and could not be formed into the environmentally protective polyurethane composite material.

Comparison 2

In the present comparison, a thermoplastic polyurethane was blended with recycled tire powder by an agitator-type blender under an operation temperature of 25° C., a screw speed of 150 revolutions per minute (r.p.m.) and a blending time of 1 hour; then a mixture was obtained. The thermoplastic polyurethane was TPU-195 manufactured by Sunko Ink. Co., Ltd. The hardness and the melt index of the thermoplastic polyurethane were 95 A and 7.164 g/10 mins, respectively. The weight ratio between the thermoplastic polyurethane and the recycled tire powder was 80:20.

The mixture was melted and extruded by an extrusion moulding machine under a melting temperature of 200° C. and a screw speed of 90 r.p.m. to obtain an environmentally protective polyurethane composite material.

However, the specific gravity and the particle size of the recycled tire powder were 1.432 and 0.1 millimeter (mm). The specific gravity and the particle size of the thermoplastic polyurethane were 1.198 and 2 millimeters. Therefore, the recycled tire powder was heavier and smaller than the thermoplastic polyurethane.

Since the recycled tire powder was heavier and smaller than the thermoplastic polyurethane, the composition distribution of the mixture was not uniform, such that the recycled tire powder was extruded first and resulted in the screw slippage. As such, the environmentally protective polyurethane composite material could not be obtained.

To sum up, by the thickening dispersant, the environmentally protective additive was uniformly added into the thermoplastic polyurethane to obtain the multifunctional environmentally protective polyurethane composite material of the present invention. Using the environmentally protective additive would not produce additional waste and would even suppress an increase of waste. In addition, as proved in Embodiments 1, 2 and 4 to 10, with the use of the thickening dispersant and the environmentally protective additive, the multifunctional environmentally protective polyurethane composite material of the present invention had advantages of light weight, good flowability, good slip resistance, good abrasion resistance and good formability. Moreover, the cost of the environmentally protective additive taken from natural products or recycled materials was low; thus, the multifunctional environmentally protective polyurethane composite material of the present invention was cost effective.

What is claimed is:

1. A polyurethane composite material, comprising:
a thermoplastic polyurethane;
an environmentally protective additive including a substance selected from the group consisting of: recycled polymer, plant fiber, mineral and metal powder; and
a thickening dispersant including a substance selected from the group consisting of: natural rubber and synthetic rubber.

2. The polyurethane composite material as claimed in claim 1, wherein a hardness of the thermoplastic polyurethane is between 6 D and 80 D.

3. The polyurethane composite material as claimed in claim 1, wherein a melt index of the thermoplastic polyurethane is between 1 gram per 10 minutes and 50 grams per 10 minutes.

4. The polyurethane composite material as claimed in claim 1, wherein the recycled polymer is selected from the group consisting of: polyethylene, polyvinyl chloride, polypropylene, polystyrene, polyethylene terephthalate, nylon, fluoride plastic, polyimide, polycarbonate, acrylonitrile butadiene styrene and tire.

5. The polyurethane composite material as claimed in claim 1, wherein the plant fiber is derived from the group consisting of: cork, bamboo charcoal, wood powder, grain shells, bagasse, coffee grounds, tea leaves, waste paper and mixtures thereof.

6. The polyurethane composite material as claimed in claim 1, wherein the mineral is selected from the group consisting of: zeolite, clay, diatomaceous earth, graphite and limestone.

7. The polyurethane composite material as claimed in claim 1, wherein the synthetic rubber of the thickening dispersant is selected from the group consisting of: polyisoprene rubber, polybutadiene rubber, acrylonitrile butadiene rubber, styrene-butadiene-styrene block copolymer, styrene-butadiene rubber, styrene-ethylene-butylene-styrene block copolymer, styrene-isoprene-styrene block copolymer and a chemically modified product thereof.

8. The polyurethane composite material as claimed in claim 1, wherein a concentration of the thickening dispersant is 0.1 to 80 weight percent based on a weight of the polyurethane composite material.

9. The polyurethane composite material as claimed in claim 1, wherein a concentration of the environmentally protective additive is 0.1 to 80 weight percent based on a weight of the polyurethane composite material.

10. The polyurethane composite material as claimed in claim 1, wherein the thermoplastic polyurethane is made from a polyol, a diisocyanate and a chain extender.

11. The polyurethane composite material as claimed in claim 10, wherein the polyol is selected from the group consisting of: polyester, polyether and polycaprolactone.

12. The polyurethane composite material as claimed in claim 10, wherein an average molecular weight of the polyol is between 500 and 5000.

13. The polyurethane composite material as claimed in claim 10, wherein the diisocyanate is selected from the group consisting of: toluene-2,4-diisocyanate, toluene-2,6-diisocyanate, 4,4′-diphenylmethane diisocyanate, 2,4′-diphenylmethane diisocyanate, polymeric diphenylmethane diisocyanate and hexamethylene diisocyanate.

14. The polyurethane composite material as claimed in claim 10, wherein the chain extender is selected from the group consisting of: ethylene glycol, 1,4-butanediol and 1,6-hexanediol.

15. A method of making the polyurethane composite material as claimed in claim 1, comprising:
blending the thermoplastic polyurethane, the environmentally protective additive and the thickening dispersant to obtain a mixture; and
molding the mixture to obtain the polyurethane composite material.

16. The method as claimed in claim 15, wherein the step of blending the thermoplastic polyurethane, the environmentally protective additive and the thickening dispersant to obtain a mixture comprises:
blending the environmentally protective additive and the thickening dispersant under an operation temperature ranging from 25° C. to 70° C., a screw speed ranging from 50 revolutions per minute to 200 revolutions per minute, and a blending time ranging from 0.5 hour to 1 hour to obtain an intermediate; and
blending the intermediate with the thermoplastic polyurethane under an operation temperature ranging from 50° C. to 60° C., a screw speed ranging from 50 revolutions per minute to 200 revolutions per minute, and a blending time ranging from 0.5 hour to 1 hour to obtain the mixture.

17. The method as claimed in claim 16, wherein the step of molding the mixture to obtain the polyurethane composite material comprises:
melting and extruding the mixture under a melting temperature ranging from 130° C. to 220° C. and a screw speed ranging from 50 revolutions per minute to 120 revolutions per minute to obtain the polyurethane composite material.
